(19) United States
(12) Patent Application Publication
(10) Pub. No.: US 2003/0169784 A1
(43) Pub. Date: Sep. 11, 2003

(54) Method and device to avoid optical damage of an intracavity optic

(76) Inventors: Dirk H. Sutter, Rottweil, DE (US); James D. Kafka, Palo Alto, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/367,590

(22) Filed: Feb. 13, 2003

Related U.S. Application Data
(60) Provisional application No. 60/363,651, filed on Mar. 8, 2002.

(51) Int. Cl. H01S 3/098; H01S 3/091; H01S 3/094; H01S 3/08

(52) U.S. Cl. 372/18; 372/75; 372/92

(57) ABSTRACT

A laser oscillator has a resonator including a high reflector, an output coupler and a gain medium is positioned in the resonator. A diode pump source is provided, the pump source and gain medium create a lensing effect in the resonator. A shutter is positioned in the resonator and is configured to prohibit oscillation in the resonator until the lensing effect is stabilized. In one embodiment, diode-pumped laser oscillators are provided where damage to intracavity elements, such as SESAM'S, is prevented.

### CROSS-REFERENCE TO RELATED APPLICATIONS

This application claims the benefit of 60/363,651, filed Mar. 8, 2002, which application is fully incorporated herein by reference.

### BACKGROUND OF THE INVENTION

1. Field of the Invention

This invention relates generally to optical oscillators, and more particularly to mode-locked lasers with semiconductor saturable absorber mirrors.

2. Description of Related Art

The resonator in a laser defines the spatial properties of the laser beam. In particular, it defines the spot size of the beam on the optical components of the resonator.

In the case of a high pump power, the gain element typically changes its focusing properties. As a result, the spot sizes change, as discussed by Vittorio Magni: “Multielement stable resonators containing a variable lens,” J. Opt. Soc. Am. A 4(10), pp. 1962-1969 (October 1987).

The spot size on one or both end mirrors of the resonator can become infinitesimally small at the edges of the stability range of the resonator. Such small spots lead to a very high intensity. Hence, the threshold intensity for optical damage can be exceeded.

Optical damage threshold is usually lowest for components that absorb at least a part of the laser light. However, it is sometimes desired to use such optics inside a laser resonator. For example, passive mode locking of a laser, in which useful, ultrafast pulses are generated, can be obtained by using devices called saturable absorber mirrors. A discussion of semiconductor saturable absorber mirrors is found in U. Keller et al.: “Semiconductor Saturable Absorber Mirrors (SESAMs) for Femtosecond to Nanosecond Pulse Generation in Solid-State Lasers,” IEEE J. Selected Topics in Quantum Electronics (JSTQE) 2(3), pp. 435-453 (September 1996). The use of such a device in a high-power mode-locked laser has been described by G. Spühler et al.: “Passively mode-locked high-power Nd:YAG lasers with multiple laser heads,” Appl. Phys. B 71, 19-25 (2000).

The SESAM is susceptible to damage when the laser intensity exceeds a critical value, i.e. when the spot size on the SESAM becomes small and/or when the circulating power in the resonator becomes large.

As discussed by C. Hönninger et al. in “Q-switching stability limits of continuous-wave passive mode locking,” J. Opt. Soc. Am. B 16(1), pp. 46-56 (January 1999), lasers containing SESAMs tend to emit Q-switched mode-locked pulses in certain parameter ranges. Such Q-switched mode-locked pulses exhibit much higher peak powers than the usually desired continuous-wave mode-locked pulses.

In particular, Q-switched mode locking is likely to occur when the laser operates close to threshold, i.e. when the gain is still low. Additionally, the infinitesimally small spot size of the intracavity beam in the gain element at the edges of the stability zones can cause Q-switching as discussed by Hönninger et al. This can happen directly after turning on the pump source when the thermal lens is first formed in the gain medium. Spiking of the laser output power is a typical dynamical behavior when the laser is switched on.

However, a mode-locked laser with a SESAM should be operated a few times above the so-called saturation intensity of the SESAM, which is close to the damage threshold. Damage is likely when, after turn-on of the pump power, the spot size at the SESAM is smaller and/or the power of the circulating light inside the resonator is higher than their respective desired values at standard operation.

While it is possible to design a laser such that the resonator remains in one stability zone for all values of the variable lens (“dynamically stable resonator”), such an approach is limiting.

U.S. Pat. No. 4,785,456 to Kaplan describes a cw YAG laser that is side-pumped by arc lamps. Kaplan mentions that thermal focusing and birefringence can vary as the pump power is changed and that this will cause a slow change in the output power. Kaplan states the “Typically, instantaneous power delivery is achieved by keeping the laser pump input at, or near the value required for the anticipated output and switching the laser on via an intracavity shutter.” See column 1, line 57. U.S. Pat. No. 4,899,343 to Wildmann discloses an Nd:YAG laser that is side-pumped by lamps. The laser disclosed by Wildmann has a safety circuit that monitors the power density in the resonator. The circuit then controls both the Q-switch and an intracavity shutter to protect an intracavity frequency doubling crystal “against dangerous power densities in the resonator.” See column 2, lines 20.

U.S. Pat. No. 5,132,980 to Connors describes a pulsed flashlamp-pumped solid-state laser. Connors describes how a side-pumped laser gain medium will “behave initially as a negative lens” but that successive pump pulses will reverse this condition and form a “stable positive lens.” See column 1, line 42. Before the lens has formed, the intracavity rays will be limited by some aperture in the laser. Fresnel diffraction effects, possibly from the gain medium itself, can lead to on axis intensity peaks and ultimately lead to coating damage to the intracavity optics. Connors states that an intracavity shutter has been used to block the intracavity beam, but teaches that “it is desirable, if not necessary, to solve the problem without adding additional physical elements to the intracavity space.” See column 2, line 18. The solution presented is to run the flash-lamps just below threshold to form the lens in the gain media without letting the laser produce any power.

The above described systems contain lasers that are side-pumped using either flash-lamps or cw arc lamps. For diode pumped lasers and particularly for end-pumped systems, the thermal lens is typically much stronger than in previous systems. Values for the thermal lens in diode-pumped end-pumped lasers can be as high as 10 diopters and do not change sign as the thermal lens forms. Damage in such systems typically occurs from small spot sizes at intracavity elements and not from diffraction effects.

In most diode-pumped systems, the lasers are run many times threshold, typically 3 times threshold and as much as 10 times. As a result, pumping just below threshold does a poor job of stabilizing the thermal lens to the correct value.

Finally SESAM's are particularly prone to damage because they must absorb some of the intracavity power. As described above, one disadvantage unique to SESAM's is that the lasers will Q-switch when run close to threshold, thus increasing the likelihood of damage.

There is a need for a diode pumped oscillator, and its methods of use, that prohibits oscillation until a thermal lens in the gain medium has stabilized. There is a further need to prevent damage to an intracavity, or extra-cavity element, in a diode pumped oscillator. Yet there is a further need to prevent damage to a SESAM in a diode pumped oscillator.

### SUMMARY OF THE INVENTION

Accordingly, and object of the present invention is to provide diode pumped laser oscillators, and their methods of use, that have a reduced thermal lens effects.

Another object of the present invention is to provide diode-pumped laser oscillators, and their methods of use, where oscillation in the resonator is prohibited until the tensing effect is stabilized.

Yet another object of the present invention is to provide diode-pumped laser oscillators, and their methods of use, where damage to SESAM'S is prevented.

These and other objects of the present invention are achieved in a laser oscillator with a resonator including a high reflector and an output coupler. A gain medium is positioned in the resonator. A diode pump source is provided, the pump source and gain medium create a lensing effect in the resonator. A shutter is positioned in the resonator and is configured to prohibit oscillation in the resonator until the lensing effect is stabilized.

In another embodiment of the present invention, a method of producing an output from a laser oscillator provides a resonator that includes a gain medium and a shutter. A diode pump source is provided. The pump source and gain medium create a lensing effect in the resonator. The shutter is opened after the lensing effect stabilizes.

In another embodiment of the present invention, a method of minimizing damage to an optical element provides a resonator that includes, a gain medium and a shutter. A diode pump source is provided. The pump source and gain medium create a lensing effect in the resonator. The shutter is closed while the lensing effect stabilizes.

### BRIEF DESCRIPTION OF THE FIGURES

FIG. 1 is a schematic diagram of one embodiment of a laser oscillator of the present invention.

FIG. 2(a) illustrates an embodiment where the thermal lens has just begun to form and the resonator cavity is near the edge of stability.

FIG. 2(b) illustrates an embodiment where the thermal lens has stabilized and the size of the beam on a SESAM has significantly increased.

### DESCRIPTION OF THE PREFERRED EMBODIMENTS

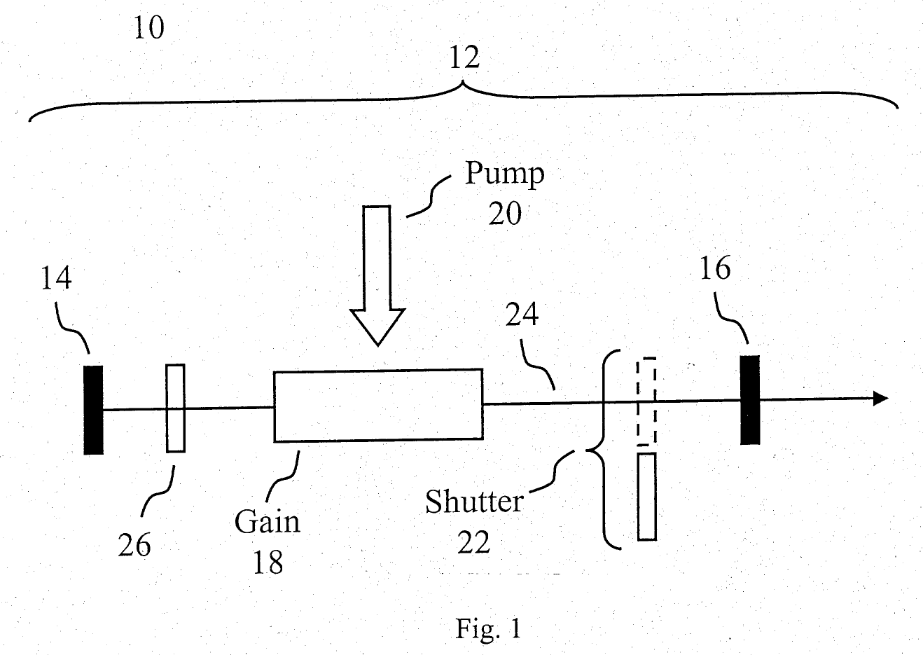

Referring to FIG. 1, in one embodiment of the present invention, a laser oscillator 10 with a resonator 12 that has a high reflector 14 and an output coupler 16. A gain medium 18 is positioned in resonator 12. A diode pump source 20 is provided, diode pump source 20 and gain medium 18 create a lensing effect in resonator 12. A shutter 22 is positioned in resonator 12 and is configured to prohibit oscillation in resonator 12 until the lensing effect is stabilized.

Resonator 12, and the lensing effect, cause an intracavity beam 24 at output coupler 16 to become small and increase an intensity of the intracavity beam at output coupler 16. Resonator 12 and the lensing effect can also cause intracavity beam 24 at high reflector 14 to become small. This increases an intensity of intracavity beam 24 at high reflector 14.

Shutter 22 is configured to block a beam path of intracavity beam 24 in resonator 12 during turn on of the pump source 20. Shutter 22 is in a closed position, for a sufficient time, to minimize changes of a spot size of intracavity beam 24 that results from varying focusing power of gain medium 18. In an embodiment of the present invention, shutter 22 is closed while the lensing effect stabilizes for a period of time that can be at least one second, at least 5 seconds, and the like. Shutter 22 opens a beam path of intracavity beam 24 in a time that suppresses high traverse mode operation while opening shutter 22. Shutter 22 can be a variety of different devices, including but not limited to, an acousto-optic device, an electro-optic device or a mechanical device such as a clapper or a relay, and the like.

In one embodiment, an optical element 26 is positioned in resonator 12. Resonator 12 and the lensing effect cause an intracavity beam at optical element 26 to become small and increase an intensity of the intracavity beam at the optical element. Examples of suitable optical elements 26 include but are not limited to, a saturable absorber device such as a semiconductor saturable absorber mirror, an acousto-optic device, an electro-optic device, a dielectric coated component, a metal coated component, and the like.

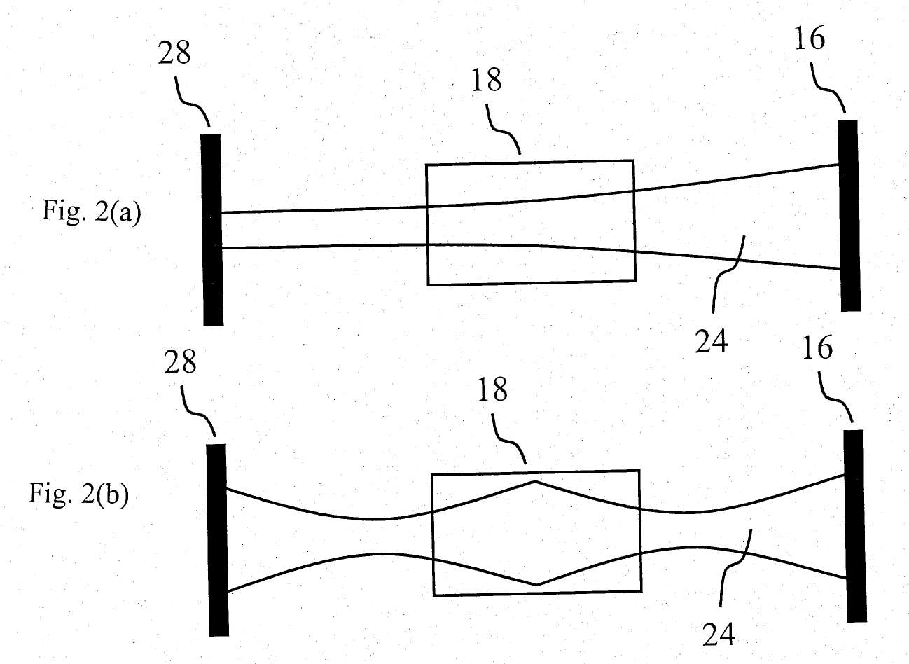

The stability of resonator 12 depends on the lensing effect. In certain embodiments, resonator 12 begins operation at the edge of a stability zone as illustrated in FIG. 2(a). Intracavity beam 24 is shown between output coupler 16 and SESAM 28. In this embodiment, the SESAM functions as both a saturable absorber and a high reflector. As illustrated in FIG. 2(a), the thermal lens has just begun to form and the cavity is near the edge of stability. The spot size on the SESAM is small and there is a significant chance of damage. Referring now to FIG. 2(b), the thermal lens has stabilized and the size of the beam on the SESAM has significantly increased.

Returning to FIG. 1, in various embodiments, shutter 22, or an equivalent device, blocks intracavity beam path 24 in resonator 12 when turning diode pump source 20 on. A few seconds after turn-on of diode pump source 20 shutter 22 is opened and oscillation starts. During the time that shutter 22 is closed the strength of the lensing effect increases and can be stronger than the steady state value. After the shutter opens, the time it takes until the laser output has stabilized to a continuous wave mode locked operation can be a millisecond or less. Moreover, resonator 12 can be stable due to the lensing effect when shutter 22 opens so that the spot size remains large on the SESAM. In various embodiments, the spot size can be at least 10 microns, at least 25 microns and the like. Preferably, the intensity on the SESAM does not increase above the damage threshold.

When shutter 22 is closed, there is no laser oscillation in resonator 12. As a result, shutter 22 does not have to dissipate any power. As such a simple device, such as a clapper or relay or the like, can be used as the shutter.

Diode pump source 20 can be any number of different sources, including but not limited to, a diode bar, a fiber coupled diode, a fiber coupled diode stack, and the like. Gain medium 18 can be a solid-state gain medium, such and Nd:YVO₄, Nd:YAG, Nd:YLF, Nd:glass, Yb:YAG, Yb:glass, Yb doped tungstates and the like.

Resonator 12 can produce a variety of different outputs, including but not limited to, an output of mode locked pulses, an output of Q-switched pulses, and the like.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A laser oscillator, comprising:
a resonator including a high reflector and an output coupler;
a gain medium positioned in the resonator
a diode pump source, the diode pump source and gain medium creating a lensing effect in the resonator; and
a shutter positioned in the resonator, the shutter configured to prohibit oscillation in the resonator until the lensing effect is stabilized.

2. The oscillator of claim 1, wherein the resonator and lensing effect causing an intracavity beam at the output coupler to become small and increase an intensity of the intracavity beam at the output coupler.

3. The oscillator of claim 1 the resonator and lensing effect causing an intracavity beam at the high reflector to become small and increase an intensity of the intracavity beam at the high reflector.

4. The oscillator of claim 3 where the high reflector is a semiconductor saturable absorber mirror.

5. The oscillator of claim 1 the resonator and lensing effect causing an intracavity beam at the gain medium to become small and increase an intensity of the intracavity beam at the gain medium.

6. The oscillator of claim 1, further comprising:
an optical element positioned in the resonator, the resonator and lensing effect causing an intracavity beam at the optical element to become small and increase an intensity of the intracavity beam at the optical element.

7. The oscillator of claim 6, wherein the optical element is a saturable absorber device

8. The oscillator of claim 7, wherein the saturable absorber device is a semiconductor saturable absorber mirror.

9. The oscillator of claim 6, wherein the optical element is an acousto-optic device.

10. The oscillator of claim 6, wherein the optical element is a non-linear device.

11. The oscillator of claim 6, wherein the optical element is an electro-optic device.

12. The oscillator of claim 6, wherein the optical element is a dielectric coated component.

13. The oscillator of claim 6, wherein the optical element is a metal coated component.

14. The oscillator of claim 1, wherein the diode pump source is a diode bar.

15. The oscillator of claim 1, wherein the diode pump source is a fiber coupled diode.

16. The oscillator of claim 1, wherein the diode pump source is a diode stack.

17. The oscillator of claim 1, wherein the gain medium is a solid-state gain medium.

18. The oscillator of claim 1, wherein the resonator produces an output of mode locked pulses.

19. The oscillator of claim 1, wherein the resonator produces an output of Q-switched pulses.

20. The oscillator of claim 1, wherein the shutter is selected from an acousto-optic device, an electro-optic device and a mechanical device.

21. The oscillator of claim 1, wherein the shutter is a mechanical shutter.

22. The oscillator of claim 1, wherein the shutter is configured to block a beam path of an intracavity beam in the laser resonator during turn on of the pump source.

23. The oscillator of claim 1, wherein the shutter is in a closed position for a sufficient time to minimize changes of a spot size of an intracavity beam that results from varying focusing power of the gain medium.

24. The oscillator of claim 1, wherein the shutter is configured to open a beam path of the intracavity beam in a time that suppresses high traverse mode operation while opening the shutter.

25. The oscillator of claim 21, wherein the shutter is a clapper.

26. The oscillator of claim 21, wherein the shutter is a relay.

27. A method of producing an output from a laser oscillator, comprising:
providing a resonator that includes, a gain medium and a shutter,
providing a diode pump source, the diode pump source and gain medium creating a lensing effect in the resonator;
opening the shutter after the lensing effect stabilizes.

28. The method of claim 27, wherein the shutter remains closed for at least 1 second.

29. The method of claim 27, wherein the shutter remains closed for at least 5 seconds.

30. The method of claim 27, wherein the diode pump source is a diode bar.

31. The method of claim 27, wherein the diode pump source is a fiber coupled diode.

32. The method of claim 27, wherein the diode pump source is a diode stack.

33. The method of claim 27, wherein the gain medium is a solid-state gain medium.

34. The method of claim 27, wherein the resonator produces an output of mode locked pulses.

35. The method of claim 27, wherein the resonator produces an output of Q-switched pulses.

36. The method of claim 27, wherein the shutter is selected from an acousto-optic device, an electro-optic device and a mechanical device.

37. The method of claim 27, wherein the shutter is a mechanical shutter.

38. The method of claim 27, wherein the shutter is configured to block a beam path of an intracavity beam in the laser resonator during turn on of the pump source.

39. The method of claim 27, wherein the shutter is in a closed position for a sufficient time to minimize changes of a spot size of an intracavity beam that results from varying focusing power of the gain medium.

40. The method of claim 27, wherein the shutter is configured to open a beam path of the intracavity beam in a time that suppresses high traverse mode operation while opening the shutter.

41. The method of claim 37, wherein the shutter is a clapper.

42. The method of claim 37, wherein the shutter is a relay.

43. A method of minimizing damage to an optical element, comprising:
providing a resonator that includes, a gain medium and a shutter,
providing a diode pump source, the diode pump source and gain medium creating a lensing effect in the resonator;
closing the shutter while the lensing effect stabilizes.

44. The method of claim 43, wherein the resonator and lensing effect causing an intracavity beam at the output coupler to become small and increase an intensity of the intracavity beam at the output coupler.

45. The method of claim 43, wherein the resonator and lensing effect causing an intracavity beam at the high reflector to become small and increase an intensity of the intracavity beam at the high reflector.

46. The oscillator of claim 45 where the high reflector is a semiconductor saturable absorber mirror.

47. The oscillator of claim 43 the resonator and lensing effect causing an intracavity beam at the gain medium to become small and increase an intensity of the intracavity beam at the gain medium.

48. The method of claim 43, further comprising:
an optical element positioned in the resonator, the resonator and lensing effect causing an intracavity beam at the optical element to become small and increase an intensity of the intracavity beam at the optical element.

49. The method of claim 48, wherein the optical element is a saturable absorber device

50. The method of claim 48, wherein the saturable absorber device is a semiconductor saturable absorber mirror.

51. The method of claim 48, wherein the optical element is an acousto-optic device.

52. The method of claim 48, wherein the optical element is a non-linear device.

53. The method of claim 48, wherein the optical element is a an electro-optic device.

54. The method of claim 48, wherein the optical element is a dielectric coated component.

55. The method of claim 48, wherein the optical element is a metal coated component.
